(19) United States
(12) Patent Application Publication
(10) Pub. No.: US 2013/0045961 A1
(43) Pub. Date: Feb. 21, 2013

(54) Personal Care Compositions Having Dried Zinc Pyrithione

(71) Applicants: Edward Dewey SMITH, III, Mason, OH (US); Jason Edward COOK, Anderson Township, OH (US)

(72) Inventors: Edward Dewey SMITH, III, Mason, OH (US); Jason Edward COOK, Anderson Township, OH (US)

(21) Appl. No.: 13/585,864

(22) Filed: Aug. 15, 2012

Related U.S. Application Data
(60) Provisional application No. 61/523,816, filed on Aug. 15, 2011.

(51) Int. Cl. A01N 55/02; A01P 1/00; C07F 3/06

(52) U.S. Cl. 514/188; 546/6; 428/402

(57) ABSTRACT

Personal care compositions including dried zinc pyrithione are provided. Methods are also provided to increase antimicrobial efficacy and enhance deposition of zinc pyrithione

### CROSS REFERENCE TO RELATED APPLICATION

This application claims the benefit of U.S. Provisional Application No. 61/523,816, filed Aug. 15, 2011, which is incorporated herein by reference.

### TECHNICAL FIELD

The present disclosure generally relates to personal care compositions comprising dried zinc pyrithione, methods of increasing antimicrobial efficacy, and methods of increasing deposition of zinc pyrithione (“ZPT”).

### BACKGROUND

Human health is impacted by many microbial entities or microbials such as germs, bacteria, fungi, yeasts, molds, viruses, or the like. For example, invasion by microbial entities including various viruses and bacteria cause a wide variety of sicknesses and ailments. To reduce such an invasion, people frequently wash their skin with antimicrobial soaps. Antibacterial soaps typically include soaps in combination with, for example, antimicrobial agents. For example, one such antibacterial soap is a bar soap with non-dried, particulate zinc pyrithione. Such bar soaps typically contain non-dried zinc pyrithione in the form of small or fine particles. When the skin is washed with an antimicrobial soap, such as a bar soap with non-dried zinc pyrithione, the surfactancy of the soap typically removes most of the microbial entities on the skin, while the antimicrobial agent, such as non-dried zinc pyrithione, deposits onto the skin to provide residual protection against subsequent invasion.

However, current antibacterial soaps can be improved if such soaps were to deposit more of the antimicrobial agent or if the antimicrobial agent was more bioavailable. By improving bioavailability and/or deposition of zinc pyrithione, enough zinc pyrithione particulates can be present to prevent subsequent invasion by gram negative bacteria such as E. coli, gram positive bacteria, and the like. Accordingly, it would be desirable to provide personal care compositions and methods for improving the antimicrobial efficacy and bioavailability.

### SUMMARY

A personal care composition comprises dried zinc pyrithione.

A method of increasing antimicrobial efficacy of zinc pyrithione, the method comprising drying zinc pyrithione to less than 25% moisture, by weight of the zinc pyrithione.

A method of enhancing deposition of zinc pyrithione includes applying a personal care composition to the skin of an individual, with the personal care composition including dried zinc pyrithione.

### DETAILED DESCRIPTION

### I. DEFINITIONS

As used herein, the following terms shall have the meaning specified thereafter:

“Anhydrous” refers to those compositions, and components thereof, which are substantially free of water.

“Bar soap” refers to compositions intended for topical application to a surface such as skin or hair to, for example, remove dirt, oil, and the like. The bar soaps can be rinse-off formulations, in which the product is applied topically to the skin or hair and then subsequently rinsed within minutes from the skin or hair with water. The product could also be wiped off using a substrate. Bar soaps can be in the form of a solid (e.g., non-flowing) bar soap intended for topical application to skin. The bar soap can also be in the form of a soft solid which is conformable to the body. The bar soap additionally can be wrapped in a substrate which remains on the bar during use.

“Dried zinc pyrithione” refers to zinc pyrithione that has about 25% or less, by weight of the zinc pyrithione, of moisture.

“Personal care composition” refers to compositions intended for topical application to skin or hair. Personal care compositions can be rinse-off formulations, in which the product can be applied topically to the skin or hair and then subsequently rinsed within minutes from the skin or hair with water. The product could also be wiped off using a substrate. In either case, it is believed at least a portion of the product is left behind (i.e. deposited) on the skin. The personal care compositions can be in the form of a liquid, semi-liquid cream, lotion, gel, solid, or combinations thereof and are intended for topical application to the skin and/or hair. Examples of personal care compositions can include but are not limited to bar soaps, shampoos, conditioning shampoos, body washes, moisturizing body washes, shower gels, skin cleansers, cleansing milks, hair and body washes, in shower body moisturizers, pet shampoos, shaving preparations, and cleansing compositions used in conjunction with a disposable cleansing cloth.

“STnS” refers to sodium trideceth(n) sulfate, wherein n can define the average number of moles of ethoxylate per molecule.

“Structured” refers to having a rheology that can confer stability on the personal care composition. A degree of structure can be determined by characteristics determined by one or more following methods: Young's Modulus Method, Yield Stress Method, or Zero Shear Viscosity Method or by a Ultracentrifugation Method, all described in U.S. Pat. No. 8,158,566, granted on Apr. 17, 2012. A cleansing phase can be considered to be structured if the cleansing phase has one or more following characteristics: (a) Zero Shear Viscosity of at least 100 Pascal-seconds (Pa-s), at least about 200 Pa-s, at least about 500 Pa-s, at least about 1,000 Pa-s, at least about 1,500 Pa-s, or at least about 2,000 Pa-s; (b) A Structured Domain Volume Ratio as measured by the Ultracentrifugation Method, of about 40% or more, about 45% or more, about 50% or more, about 55% or more, about 60% or more, about 65% or more, about 70% or more, about 75% or more, about 80% or more, about 85% or more, or about 90% or more; or (c) A Young's Modulus of about 2 Pascals (Pa) or more, about 10 Pa or more, about 20 Pa or more, about 30 Pa or more, about 40 Pa or more, about 50 Pa or more, about 75 Pa or more, or about 100 Pa or more.

### II. DRIED ZINC PYRITHIONE AND PERSONAL CARE COMPOSITIONS

Many current antibacterial soaps work by depositing an antimicrobial agent on the skin. The length of the effect of the antibacterial soap, however, depends on both the amount of antimicrobial agent deposited and on the efficiency of the antimicrobial agent deposited. It has surprisingly been found that dried zinc pyrithione can be effective in increasing the antimicrobial efficacy on the surface to which it is applied and can be effective in increasing the efficiency on, for example, a mass basis of the amount of zinc pyrithione deposited on the surface of the skin of an individual.

For example, Table 1, below, shows results for a pig skin residual efficacy test following treatment of pig skins with a bar soap comprising 0.2% FPS zinc pyrithione (Comparative Example 8) and a bar soap comprising 0.2% dried zinc pyrithione powder (Inventive Example 5). The data includes log cfu reduction measurements following a five-hour incubation period and the reduction is quantified versus the amount of cfu's in a placebo treatment. As illustrated, treatment with a bar soap comprising dried zinc pyrithione exhibits greater antimicrobial efficacy (i.e. a larger CFU reduction (log)) relative to a bar soap comprising colloidal zinc pyrithione. The pig skin residual efficacy test is described below.

TABLE 1
CFU Reduction (log)

| | Comparative Example 8 | Inventive Example 5 |
|---|---|---|
| Mean | 1.17 | 2.59 |
| SD | 1.11 | 1.55 |
| SE | 0.55 | 1.09 |

Additionally, Table 2 shows results for a cup scrub test for measuring deposition of zinc pyrithione on a pig skin following treatment of pig skins with a bar soap comprising 0.2% FPS zinc pyrithione (Comparative Example 8) and a bar soap comprising 0.2% dry zinc pyrithione (Inventive Example 5). As illustrated, the formulation comprised of dry zinc pyrithione provided enhanced deposition of the antibacterial ingredient to the skin relative to colloidal zinc pyrithione.

TABLE 2
Deposition of ZPT (μg/cm²) Following Treatment with Bar Soap
Containing 0.2% ZPT

| | Comparative Example 8 | Inventive Example 5 |
|---|---|---|
| Mean | None Detected | 0.053 |
| SD | — | 0.077 |
| SE | — | 0.038 |

Table 3 shows results for a cup scrub test for measuring deposition of zinc pyrithione on pig skin following treatment of pig skins with a bar soap comprising 0.5% FPS zinc pyrithione (Comparative Example 7) and a bar soap comprising 0.5% spray-dried zinc pyrithione (Inventive Example 4). As illustrated in Table 3, a formulation comprising spray-dried zinc pyrithione deposits more of the antibacterial ingredient than a formulation comprising colloidal zinc pyrithione. Additionally, while FPX ZPT was deposited at a detectable level when present at 0.5% in a bar soap formulation, it was not deposited at a detectable level when present at 0.2% in a bar soap formulation. Thus, the combination of data from Tables 2 and 3 shows dried ZPT can deposit when present at much lower levels in a composition than FPS ZPT.

TABLE 3
Deposition of ZPT (μg/cm²) Following Treatment with Bar Soap
Containing 0.5% ZPT

| | Comparative Example 7 | Inventive Example 4 |
|---|---|---|
| Mean | 0.160 | 0.335 |
| SD | 0.101 | 0.229 |
| SE | 0.032 | 0.066 |

Conventional zinc pyrithione can be made, for example, by reacting 1-hydroxy-2-pyridinethione (i.e., pyrithione acid) or a soluble salt thereof with a zinc salt (e.g. zinc sulfate) to form a zinc pyrithione precipitate as illustrated in U.S. Pat. No. 2,809,971, and the zinc pyrithione can be formed or processed into platelets using, for example, sonic energy as illustrated in U.S. Pat. No. 6,682,724. These processes, however, do not include drying. Conventional zinc pyrithione is often in a slurry form (i.e. particles in water) and one example of a conventional ZPT in slurry form, FPS ZPT, has a moisture content of about 52%.

Dried zinc pyrithione can be formed from one or more of a variety of drying processes. Examples of such drying processes can include, but are not limited to spray drying, tray drying, tunnel drying, roller drying, fluidized bed drying, pneumatic drying, rotary drying, trough drying, bin drying, belt drying, vacuum drying, drum drying, infrared drying, microwave drying, and radiofrequency drying.

A drying process can be utilized to reduce the amount of moisture in zinc pyrithione. Dried zinc pyrithione may have a moisture content of about 25% or less, by weight of the dried zinc pyrithione. The dried zinc pyrithione may have an even lower moisture content, for example by being dried further, and that moisture content could be 22%, 20, 18, 15, 12, 10, 8, 6, 5, 3, or 1%, or less, by weight of the dried zinc pyrithione. While some types of drying are exemplified herein, any appropriate method to reduce moisture level can be used.

Dried zinc pyrithione may be subject to further processing, like milling, depending on the requirements for the particular application. Examples of milling can include, but are not limited to pin milling and jet milling.

Dried zinc pyrithione can further be treated before being used in a personal care composition. For example, zinc pyrithione can be stabilized against flocculation. Thus, dried zinc pyrithione (e.g., particulate and/or platelet form) used in a personal care composition may have a surface modification thereon to prevent the particulates and/or platelets from attaching to each other. The surface modification can include polynaphthalene sulfonate or any other suitable sulfate, sulfonate, carboxylate, or other compound that provides stability, for example, by charge or steric barrier on a surface.

Primary particles of zinc pyrithione can be formed from a precipitation process, and upon being dried, can join together to form larger, aggregate particles. Primary particles of dried zinc pyrithione can be, for example, in the form of particulates, platelets, or a combination thereof. The primary particles can, for example, comprise an average primary particle size from about 0.1 μm to about 5 μm. Dried zinc pyrithione primary particulates can, for example, comprise an average particle size from about 0.3 μm to about 15 μm or from about 0.5 μm to about 10 μm. Aggregate particulates can comprise an aggregate mean particle size from about 0.3 microns to about 25 microns. One means of determining aggregate particle is with conventional light scattering techniques for powders using e.g., a Malvern Mastersizer.

Primary particles and aggregate particles can be bound during a drying process by atomic or molecular forces. Zinc pyrithione can be dried with excipients, for example, materials that enhance bioactivity. Examples of suitable bioactivity enhancing excipients include metallic carbonates, auxiliary active such as selenium compounds, organic actives such as triclosan or trichlorocarbanilide, acidic or basic actives, combinations thereof, and the like. Additionally, properties of aggregate particles can be manipulated in order to change bioavailability. For example, aggregate particles can be formed so as to contain no internal porosity or aggregate particles can be formed with void spaces to have a high internal porosity such that the aggregate particles can maintain properties relating to surface area.

Without wishing to be bound by theory, it is believed that a personal care composition including dried zinc pyrithione can provide zinc pyrithione having a primary particle size, an aggregate particle size, and a frangibility to increase efficacy and deposition. In particular, it is believed that an aggregate particle can more readily engage a surface of the skin of an individual, and as the aggregate particle breaks apart into primary particles, the dried zinc pyrithione can be more readily deposited on the skin, thus enhancing deposition of the zinc pyrithione. The aggregate particles can be durable to survive processing into the personal care composition. However, the aggregate particles can also be frangible such that abrasive forces used during application to the skin and/or hair can release the primary particles from the aggregate particles. Further, it is believed that increasing the surface area of the zinc pyrithione increases its bioavailability and this increases its efficacy. This can be done, for example, by making thinner particles or by introducing void spaces into the particles. It is believed the dried ZPT can have an increased surface area due to its structure containing void spaces.

### Personal Care Composition

A personal care composition can include dried zinc pyrithione. The zinc pyrithione may be present from about 0.01% to about 5%, by weight of the personal care composition. It may be present at even smaller amounts like from about 0.05% to about 2%, from about 0.1% to about 2%, or at about 0.5%, by weight of the personal care composition, for example.

Many personal care compositions can be water-based. As such, a personal care composition can include from about 0.1% to about 35%, from about 0.3% to about 20%, or about 10%, by weight of the personal care composition, of water. It should be understood that an amount of water can be lost, i.e. evaporated, during a process of making a personal care composition, or subsequently, with water being absorbed by surrounding packaging (e.g. a cardboard carton), and the like. Thus, a personal care composition can also include materials that tend to bind the water such that the water can be maintained in the personal care composition at the desired levels. Examples of such materials can include carbohydrate structurants and humectants such as glycerin. However, it will be appreciated that a personal care composition can be anhydrous.

A variety of optional ingredients can also be added to a personal care composition. Such suitable ingredients can include, but are not limited to, structurants, humectants, fatty acids, inorganic salts, and other antimicrobial agents or actives.

A personal care composition can also optionally include hydrophilic structurants such as carbohydrate structurants and gums. Some suitable carbohydrate structurants include raw starch (corn, rice, potato, wheat, and the like) and pregelatinized starch. Some suitable gums include carregeenan and xanthan gum. A personal care composition may include from about 0.1% to about 30%, from about 2% to about 25%, or from about 4% to about 20%, by weight of the personal care composition, of a carbohydrate structurant.

A personal care composition can also optionally include one or more humectants. Examples of such humectants can include polyhydric alcohols. Further, humectants such as glycerin can be included the personal care composition as a result of production or as an additional ingredient. For example, glycerin can be a by-product after saponification of the personal care composition. Including additional humectant can result in a number of benefits such as improvement in hardness of the personal care composition, decreased water activity of the personal care composition, and reduction of a weight loss rate of the personal care composition over time due to water evaporation.

A personal care composition can optionally include inorganic salts. Inorganic salts can help to maintain a particular water content or level of the personal care composition and improve hardness of the personal care composition. The inorganic salts can also help to bind the water in the personal care composition to prevent water loss by evaporation or other means. A personal care composition can optionally include from about 0.01% to about 15%, from about 1% to about 12%, or from about 2.5% to about 10.5%, by weight of the personal care composition, of inorganic salt. Examples of suitable inorganic salts can include magnesium nitrate, trimagnesium phosphate, calcium chloride, sodium carbonate, sodium aluminum sulfate, disodium phosphate, sodium polymetaphosphate, sodium magnesium succinate, sodium tripolyphosphate, aluminum sulfate, aluminum chloride, aluminum chlorohydrate, aluminum-zirconium trichlorohydrate, aluminum-zirconium trichlorohydrate glycine complex, zinc sulfate, ammonium chloride, ammonium phosphate, calcium acetate, calcium nitrate, calcium phosphate, calcium sulfate, ferric sulfate, magnesium chloride, magnesium sulfate, and tetrasodium pyrophosphate.

A personal care composition can optionally further include one or more additional antibacterial agents that can serve to further enhance antimicrobial effectiveness of the personal care composition. A personal care composition can include, for example, from about 0.001% to about 2%, from about 0.01% to about 1.5%, or from about 0.1% to about 1%, by weight of the personal care composition, of additional antibacterial agent(s). Examples of suitable antibacterial agents can include carbanilides, triclocarban (also known as trichlorocarbanilide), triclosan, a halogenated diphenylether available as DP-300 from Ciba-Geigy, hexachlorophene, 3,4,5-tribromosalicylanilide, and salts of 2-pyridinethiol-1-oxide, salicylic acid, and other organic acids. Other suitable antibacterial agents are described in U.S. Pat. No. 6,488,943.

Solid Personal Care Compositions

As noted herein, personal care compositions can take on numerous forms. One suitable form is that of a solid personal care composition. Solid compositions can take many forms like powder, pellets, bars, etc. These forms will generally be described herein as bar soap, but it should be understood that the solid composition could be in another form or shape. One example of a bar soap personal care composition can include from about 0.1% to about 35%, by weight of the personal care composition, of water, from about 45% to about 99%, by weight of the personal care composition, of soap, and from about 0.01% to about 5%, by weight of the personal care composition, of dried zinc pyrithione. Another suitable antimicrobial bar soap can include, for example, from about 0.1% to about 30%, by weight of the personal care composition, of water, from about 40% to about 99%, by weight of the personal care composition, of soap, and from about 0.01% to about 1%, by weight of the personal care composition, of dried zinc pyrithione.

Bar soap compositions can be referred to as conventional solid (i.e. non-flowing) bar soap compositions. Some bar soap composition comprise convention soap, while others contain synthetic surfactants, and still others contain a mix of soap and synthetic surfactant. Bar compositions may include, for example, from about 0% to about 45% of a synthetic anionic surfactant. An example of a suitable conventional soap can include milled toilet bars that are unbuilt (i.e. include about 5% or less of a water-soluble surfactancy builder).

A personal care bar composition can include, for example from about 45% to about 99% or from about 50% to about 75%, by weight of the personal care composition, of soap. Such soaps can include a typical soap, i.e., an alkali metal or alkanol ammonium salt of an alkane- or alkene monocarboxylic acid. Sodium, magnesium, potassium, calcium, mono-, di- and tri-ethanol ammonium cations, or combinations thereof, can be suitable for a personal care composition. The soap included in a personal care composition can include sodium soaps or a combination of sodium soaps with from about 1% to about 25% ammonium, potassium, magnesium, calcium, or a mixture of these soaps. Additionally, the soap can be well-known alkali metal salts of alkanoic or alkenoic acids having from about 12 to about 22 carbon atoms or from about 12 to about 18 carbon atoms. Another suitable soap can be alkali metal carboxylates of alkyl or alkene hydrocarbons having from about 12 to about 22 carbon atoms. Additional suitable soap compositions are described in U.S. patent application Ser. No. 13/036,889.

A personal care composition can also include soaps having a fatty acid. For example, one bar soap composition could use from about 40% to about 95% of soluble alkali metal soap of C₈-C₂₄ or C₁₀-C₂₀ fatty acids. The fatty acid may, for example, have a distribution of coconut oil that can provide a lower end of a broad molecular weight range or a fatty acid distribution of peanut or rapeseed oil, or their hydrogenated derivatives, which can provide an upper end of the broad molecular weight range. Other such compositions can include a fatty acid distribution of tallow and/or vegetable oil. The tallow can include fatty acid mixtures that can typically have an approximate carbon chain length distribution of 2.5% C₁₄, 29% C₁₆, 23% C₁₈, 2% palmitoleic, 41.5% oleic, and 3% linoleic. The tallow can also include other mixtures with a similar distribution, such as fatty acids derived from various animal tallows and/or lard. In one example, the tallow can also be hardened (i.e., hydrogenated) such that some or all unsaturated fatty acid moieties can be converted to saturated fatty acid moieties.

Suitable examples of vegetable oil include palm oil, coconut oil, palm kernel oil, palm oil stearine, soybean oil, and hydrogenated rice bran oil, or mixtures thereof, since such oils can be among more readily available fats. One example of a suitable coconut oil can include a proportion of fatty acids having at least 12 carbon atoms of about 85%. Such a proportion can be greater when mixtures of coconut oil and fats such as tallow, palm oil, or non-tropical nut oils or fats can be used where principle chain lengths can be C₁₆ and higher. The soap included in a personal care composition can be, for example, a sodium soap having a mixture of about 67-68% tallow, about 16-17% coconut oil, about 2% glycerin, and about 14% water.

Soap included in a personal care composition can also be unsaturated in accordance with commercially acceptable standards. For example, a soap included in a personal care composition could include unsaturation in a range of from about 37% to about 45% of saponified material.

Soaps included in a personal care composition can be made, for example, by a classic kettle boiling process or modern continuous soap manufacturing processes wherein natural fats and oils such as tallow or coconut oil or their equivalents can be saponified with an alkali metal hydroxide using procedures well known to those skilled in the art. Soap can also be made by neutralizing fatty acids such as lauric (C₁₂), myristic (C₁₄), palmitic (C₁₆), or stearic (C₁₈) acids, with an alkali metal hydroxide or carbonate.

Soap included in a personal care composition could also be made by a continuous soap manufacturing process. The soap could be processed into soap noodles via a vacuum flash drying process. One example of a suitable soap noodle comprises about 67.2% tallow soap, about 16.8% coconut soap, about 2% glycerin, and about 14% water, by weight of the soap noodle. The soap noodles can then be utilized in a milling process to finalize a personal care composition.

A personal care composition can also optionally include one or more free fatty acids at an amount of from about 0.01% to about 10%, from about 0.5% to about 2%, or from about 0.75% to about 1.5%, by weight of the personal care composition. Free fatty acids can be included in the personal care composition to provide enhanced skin feel benefits such as softer and smoother feeling skin. Suitable free fatty acids can include tallow, coconut, palm, and palm kernel fatty acids.

Liquid Personal Care Compositions

Personal care compositions can take on many forms and one of those suitable forms can be a liquid form. Examples of personal care compositions in liquid form can include hand soap, body wash, hand sanitizers, etc. Such liquid-based personal care compositions can include a cleansing phase and/or a benefit phase (i.e., a single- or multi-phase composition). Each of a cleansing phrase or a benefit phase can include various components. The liquid composition can have multiple phases in varying combinations. For example, a personal care composition can include two cleansing phase, a cleansing phase and a benefit phase, two benefit phases, or any acceptable combination of phases. Additionally, the phases in a multi-phase composition can be blended, separate, or a combination thereof. The phases may also form a pattern (e.g. striped). A personal care composition may be micellar, lamellar, or a combination thereof. A personal care composition could comprise at least a 70% lamellar structure. A dried ZPT may be placed in a cleansing phase.

A cleansing phase may be aqueous or anhydrous. A cleansing phase may also, for example, include alcohol. A cleansing phase may comprise a surfactant. Surfactants suitable for use herein include anionic, zwitterionic, amphoteric, and combinations thereof. One example of a suitable surfactant comprises sodium laureth-1 sulfate, such that the dried zinc pyrithione can be used in a micellar body wash, which is described in greater detail below.

A cleansing phase may include an aqueous structured surfactant phase from about 5% to about 20%, by weight of the personal care composition. Such a structured surfactant phase can include, for example, sodium trideceth(n) sulfate, hereinafter STnS, wherein n can define average moles of ethoxylation. n can range from about 0 to about 3, from about 0.5 to about 2.7, from about 1.1 to about 2.5, from about 1.8 to about 2.2, or n can be about 2. When n can be less than 3, STnS can provide improved stability, improved compatibility of benefit agents within personal care compositions, and increased mildness of the personal care compositions, such described benefits of STnS are disclosed in U.S. patent application Ser. No. 13/157,665.

A cleansing phase can also comprise at least one of an amphoteric surfactant and a zwitterionic surfactant. Suitable amphoteric or zwitterionic surfactants can include, for example, those described in U.S. Pat. No. 5,104,646 and U.S. Pat. No. 5,106,609.

A cleansing phase can also comprise a structuring system. One example of a structuring system includes a non-ionic emulsifier, an associative polymer, an electrolyte, or a combination thereof.

A personal care composition can be optionally free of sodium lauryl sulfate, hereinafter SLS. However, when SLS is present, suitable examples of SLS are described in U.S. patent application Ser. No. 12/817,786.

A personal care composition can include from about 0.1% to 20%, by weight of the personal care composition, of a cosurfactant. Cosurfactants can comprise amphoteric surfactants, zwitterionic surfactants, or mixtures thereof. Examples of suitable amphoteric or zwitterionic surfactants can include those described in U.S. Pat. No. 5,104,646 and U.S. Pat. No. 5,106,609.

Amphoteric surfactants can include those that can be broadly described as derivatives of aliphatic secondary and tertiary amines in which an aliphatic radical can be straight or branched chain and wherein an aliphatic substituent can contain from about 8 to about 18 carbon atoms such that one carbon atom can contain an anionic water solubilizing group, e.g., carboxy, sulfonate, sulfate, phosphate, or phosphonate. Examples of compounds falling within this definition can be sodium 3-dodecyl-aminopropionate, sodium 3-dodecylaminopropane sulfonate, sodium lauryl sarcosinate, N-alkyltaurines such as the one prepared by reacting dodecylamine with sodium isethionate according to the teaching of U.S. Pat. No. 2,658,072, N-higher alkyl aspartic acids such as those produced according to the teaching of U.S. Pat. No. 2,438,091, and products described in U.S. Pat. No. 2,528,378. Other examples of amphoteric surfactants can include sodium lauroamphoacetate, sodium cocoamphoactetate, disodium lauroamphoacetate disodium cocodiamphoacetate, and mixtures thereof. Amphoacetates and diamphoacetates can also be used.

Zwitterionic surfactants suitable for use can include those that are broadly described as derivatives of aliphatic quaternary ammonium, phosphonium, and sulfonium compounds, in which aliphatic radicals can be straight or branched chains, and wherein an aliphatic substituent can contain from about 8 to about 18 carbon atoms such that one carbon atom can contain an anionic group, e.g., carboxy, sulfonate, sulfate, phosphate, or phosphonate. Other zwitterionic surfactants can include betaines, including cocoamidopropyl betaine.

Other optional additives can be included in the cleansing phase, including for example emulsifiers (e.g., non-ionic emulsifier) and electrolyes. Suitable emulsifiers and electrolytes are described in U.S. patent application Ser. No. 13/157,665.

Personal care compositions can also include a benefit phase. The benefit phase can be hydrophobic and/or anhydrous. The benefit phase can also be substantially free of or free of surfactant. A benefit phase can also include a benefit agent. In particular, a benefit phase can comprise from about 0.1% to about 50%, by weight of the personal care composition, of a benefit agent or from about 0.5% to about 20%, by weight of the personal care composition, of a benefit agent. Examples of the benefit agent can include petrolatum, glyceryl monooleate, mineral oil, triglycerides, soybean oil, castor oil, soy oligomers, and mixtures thereof. Additional examples of benefit agents can include water insoluble or hydrophobic benefit agents. Other suitable benefit agents are described in U.S. patent application Ser. No. 13/157,665. The benefit phase may also comprise a dried zinc pyrithione.

Non-limiting examples of glycerides suitable for use as hydrophobic skin benefit agents herein can include castor oil, safflower oil, corn oil, walnut oil, peanut oil, olive oil, cod liver oil, almond oil, avocado oil, palm oil, sesame oil, vegetable oils, sunflower seed oil, soybean oil, vegetable oil derivatives, coconut oil and derivatized coconut oil, cottonseed oil and derivatized cottonseed oil, jojoba oil, cocoa butter, and combinations thereof.

Non-limiting examples of alkyl esters suitable for use as hydrophobic skin benefit agents herein can include isopropyl esters of fatty acids and long chain esters of long chain (i.e. C10-C24) fatty acids, e.g., cetyl ricinoleate, non-limiting examples of which can include isopropyl palmitate, isopropyl myristate, cetyl riconoleate, and stearyl riconoleate. Other examples can include hexyl laurate, isohexyl laurate, myristyl myristate, isohexyl palmitate, decyl oleate, isodecyl oleate, hexadecyl stearate, decyl stearate, isopropyl isostearate, diisopropyl adipate, diisohexyl adipate, dihexyldecyl adipate, diisopropyl sebacate, acyl isononanoate lauryl lactate, myristyl lactate, cetyl lactate, and combinations thereof.

Non-limiting examples of alkenyl esters suitable for use as hydrophobic skin benefit agents herein can include oleyl myristate, oleyl stearate, oleyl oleate, and combinations thereof.

Non-limiting examples of polyglycerin fatty acid esters suitable for use as hydrophobic skin benefit agents herein can include decaglyceryl distearate, decaglyceryl diisostearate, decaglyceryl monomyriate, decaglyceryl monolaurate, hexaglyceryl monooleate, and combinations thereof.

Non-limiting examples of lanolin and lanolin derivatives suitable for use as hydrophobic skin benefit agents herein can include lanolin, lanolin oil, lanolin wax, lanolin alcohols, lanolin fatty acids, isopropyl lanolate, acetylated lanolin, acetylated lanolin alcohols, lanolin alcohol linoleate, lanolin alcohol riconoleate, and combinations thereof.

Non-limiting examples of silicone oils suitable for use as hydrophobic skin benefit agents herein can include dimethicone copolyol, dimethylpolysiloxane, diethylpolysiloxane, mixed C1-C30 alkyl polysiloxanes, phenyl dimethicone, dimethiconol, and combinations thereof. Nonlimiting examples of silicone oils useful herein are described in U.S. Pat. No. 5,011,681. Still other suitable hydrophobic skin benefit agents can include milk triglycerides (e.g., hydroxylated milk glyceride) and polyol fatty acid polyesters.

### Methods

To increase antimicrobial efficacy and/or deposition of zinc pyrithione, a personal care composition comprising the dried zinc pyrithione can be applied to the skin of an individual. The dried zinc pyrithione may, for example, have a moisture content of about 15% or less. One exemplary personal care composition comprises from about 0.1% to about 35%, by weight of the personal care composition, of water; from about 45% to about 99%, by weight of the person care composition, of soap; and from about 0.01% to about 5%, by weight of the personal care composition, of dried zinc pyrithione. While only a couple of personal care composition ingredients and properties are discussed in association with this method for brevity, the personal care composition herein may contain any of the ingredients and/or properties as discussed above.

Further, and as shown in Table 3, a method for enhancing deposition of zinc pyrithione can effect a deposition of about 0.05 μg/cm² or greater of the dried zinc pyrithione to the skin. A method for enhancing deposition of zinc pyrithione can effect a deposition from about 0.1 μg/cm² to about 1.0 μg/cm² of the dried zinc pyrithione to the skin. There are added benefits to deposited more zinc pyrithione on the skin as discussed above. The method can include, for example, applying a personal care composition comprising dried zinc pyrithione to the skin of an individual. While only a couple of personal care composition ingredients and properties are discussed in association with this method for brevity, the personal care composition herein may contain any of the ingredients and/or properties as discussed above.

### III. PROCEDURES

A. Drying Techniques used for Preparing Dried Zinc Pyrithione

### Spray Drying

Zinc pyrithione can be obtained as a slurry of a 49% active suspension of Fine Particle Size (FPS) Zinc Omadine®, which is stabilized by surface-adsorbed polynaphthalene sulfonate. The zinc pyrithione particles have a mean diameter of about 0.75 microns as determined by light scattering. A slurry was spray dried using a Büchi Mini Spray Dryer B290 with an inlet temperature of 200° C. and an outlet temperature of 100° C. The slurry flow rate was controlled by adjusting the peristaltic pump control to 35% of a maximum pump speed. The compressed air flow rate for a feed dispersion was set to approximately 600 L/hr. The spray-dried zinc pyrithione aggregate particles are observed to have particle size of about 10 microns to about 100 microns by light microscopy with an average diameter of about 60 microns, while being comprised of distinct primary particle subunits, which are the original FPS particles. The particles are spherical. Void space between the primary particles can increase an apparent surface area of the aggregate such that the particle can have properties such as a dissolution rate governed by the specific interface of the primary particles, about 9×10⁵ cm²/cm³. Advantageously, the particle is disintegrable, or frangible, under reasonable application of force, fracturing under applied pressure to a microscope cover slip.

### Tray Drying

Zinc pyrithione can be obtained as a slurry of a 49% active suspension of Fine Particle Size (FPS) Zinc Omadine®, which is stabilized by surface-adsorbed polynaphthalene sulfonate. The FPS zinc pyrithione particles have a mean diameter of about 0.75 microns as determined by light scattering. The slurry was placed in an aluminum foil boat, which was subsequently placed into a drying oven (temperature=45° C.). Once thoroughly dry, the material was removed from the foil and mechanically broken into small particles. The fractions were sieved using U.S. Standard Sieves to yield particle-size fractions based on the sieve mesh sizes indicated.

B. Pig Skin Residual Efficacy Test

To prepare a placebo, perform a one wash/rinse performance protocol. In particular, generate an overnight bacterial culture of E. coli (strain 10536, 8879, or 11259) by inoculating 50 mL of TSB with one colony obtained from a Tryptic Soy Agar (TSA) streak plate. Grow the culture for 17-18 hr, 37° C., 200 rpm in a dry shaker.

To determine efficacy of a bar soap, perform bar soap ex vivo performance tests on pigskins. First, obtain, clean, refrigerate, and irradiate (25-40 kGy) the pigskins. Store the irradiated pigskins at −20° C. until testing. To test bar soap compositions, thaw 10×10 cm pigskins to room temperature for 1 hour, and cut the pigskins into 5×10 cm sections using a sterile scalpel.

Using a gloved hand, wash the pigskins as follows: Rinse a 5×10 cm pigskin for 15 seconds, with tap water at 33-36° C. with a flow rate of 4 to 4.2 L/min. Wet the bar soap composition in the running water for 5 seconds, lay the bar composition flat on the pigskin surface, then immediately rub the bar soap composition gently across the entire pigskin surface for 15 seconds using back and forth motions and light hand pressure similar to that during conventional hand washing. Then, generate lather by continuously rubbing the pigskin for 45 seconds with the hand (e.g. absent the bar soap composition). Rinse the pigskin with tap water for 15 seconds by holding the tissue at a 45 degree angle and allowing the water to impinge on the top surface and cascade downwards across the entire surface. Lightly pat the pigskin dry with a sterile tissue, and allow the pigskin to dry for 5-10 minutes in still room air under low light conditions.

Cut the pigskin into 2×2.5 cm slices and inoculate each slice with 106-107 cfus by using 10 μL of a 1:20 dilution of Tryptic Soy Broth (TSB) obtained from an overnight culture as described above. Allow the bacteria to dry on the slice of the pigskin surface for 20 minutes, then place the slice of the pigskin into a humidified chamber (60% RH, 33° C.), and incubate the slices for 0 hours, 2 hours, or 5 hours. After incubation, place the slice into a jar containing 50 mL of ice cold neutralization buffer of Modified Leethen Broth with 1.5% Tween-80 and 1% Lecithin (MBL-T), and vigorously shake the buffer with the slice therein for 1 minute to elute bacteria. As necessary, dilute the suspension in MBL-T and place the suspension onto Tryptic Soy Agar (TSA) plates to obtain cell counts. Incubate the plates for 24 hours, at 33° C., and 60% Relative Humidity. Then, count the TSA plates (e.g. the cfus thereof) to calculate the cfu/mL and generate a growth curve using GraphPad Prism v4.1. Perform the test described above once to calculate the cfu/mL and to generate the growth curve. (Note: The test described above can also be performed multiple times and the data for each repetition can be averaged).

C. Cup Scrub Procedure for Measuring Deposition

As noted herein, the Cup Scrub Procedure can be used to assist in determining how much zinc-containing and/or pyrithione material is deposited onto a pig skin. First, wet a target substrate surface under running water (flow=4.5 L/min, temp=35-38° C.) for approximately 15 seconds. Next, apply a dose of 1 mL of body wash (via disposable syringe) to the target substrate surface. Proceed to generate lather on the target substrate by rubbing the applied body wash by hand for approximately 15 seconds. Following the 15-second lathering process, the lather is allowed to sit undisturbed on the pig skin for an additional 15 seconds. At the end of the 15-second wait (30 seconds after the start of the lathering process), rinse the pig skin for approximately 10 seconds, allowing the running water to contact the target substrate surface and cascade down (toward the distal surface). Following the rinse, use a paper towel to pat the surface dry.

The next part of the procedure involves a 2-cm diameter glass cylinder containing a bead of silicone caulking on a skin contact edge which will be pressed firmly against a pig skin surface to prevent leakage of an extraction fluid. One mL of the extraction solvent can be pipetted into the glass cylinder. To determine how much zinc pyrithione is deposited, for example, the extraction solvent can be 80:20 0.05 M EDTA:EtOH. While using a transfer pipette or glass rod, an entire area within the glass cylinder can be scrubbed for about 30 seconds using moderate pressure. The solution can be removed and pipetted into a labeled glass sample vial. The Cup Scrub Procedure can be repeated using fresh extraction solution, which will be pooled with the initial extraction in the labeled vial.

After each use, the glass cylinder and rod can be cleaned. The cleaning can be done, for example, by immersing each cylinder and rod in dilute Dawn® solution and scrubbed with a finger or soft bristle brush. The cylinders and rods can then be immersed in IPA. Finally, cylinders and rods can be wiped dry with a Kimwipe or other lint free tissue to remove any visible residue. Scrub solutions can be changed at an end of each day or when any visible layer of residue can be found in the bottom thereof. Further, samples can be stored at 4° C. (±3° C.) until the samples can be submitted for HPLC analysis. HPLC analysis is then used to determine the amount of deposition. The free pyrithione in solution is then derivatized with 2-2′-Dithiopyridine, and subsequently analyzed via HPLC utilizing UV detection. The results are reported as μg of zinc pyrithione per mL of solution.

### IV. EXAMPLES

### Example 1

Spray-dried zinc pyrithione was prepared as noted above in the Spray Drying method. This spray dried zinc pyrithione was then formulated into formulas as noted below.

### Example 2

Dried zinc pyrithione powder was obtained having a mean diameter of about 5 microns. Particles are irregularly shaped agglomerates of primary particles having a primary particle size of about 1 micron. Dispersed in mineral oil on a microscope slide, the particles do not readily redisperse into their primary particles.

### Examples 3A, 3B, and 3C

Tray dried zinc pyrithione was prepared as noted above. Utilizing different sieves, the following particle distributions were collected.

| | | |
|---|---|---|
| Example 3A | <600 | microns |
| Example 3B | 600-850 | microns |
| Example 3C | 850-1,500 | microns |

### Examples 4-8

### Bar Soap

A bar soap is prepared comprising spray-dried zinc pyrithione. Soap noodles, made via a conventional process involving a crutching step and vacuum drying step, are blended with dried zinc pyrithione in an amalgamator. A soap mixture is then processed through conventional milling, plodding, and stamping steps to yield finished bar compositions.

| | Example 4: | Example 5: | Example 6: | Example 7: | Example 8: |
|---|---|---|---|---|---|
| | 0.5% ZPT Bar | 0.5% ZPT Bar | 0.5% ZPT Bar | Comparative | Comparative |
| | (spray-dried | (dried ZPT | (tray-dried | (non-dried | (non-dried |
| Ingredient | ZPT), wt. % | powder), wt. % | ZPT), wt. % | ZPT), wt. % | ZPT), wt. % |
| Sodium tallowate | 67.64 | 67.84 | 67.64 | 67.64 | 67.64 |
| Sodium palm kernelate | 17.26 | 17.32 | 17.26 | 17.26 | 17.32 |
| Water | 12.99 | 13.03 | 12.99 | 12.99 | 13.03 |
| Sodium chloride | 0.62 | 0.62 | 0.62 | 0.62 | 0.62 |
| Spray-Dried ZPT (active | 0.5 | — | — | — | — |
| particle example 1) | | | | | |
| Dried ZPT Powder (active | — | 0.2 | — | — | — |
| particle example 2) | | | | | |
| Tray-Dried ZPT (active | — | — | 0.5 | — | — |
| particle example 3A) | | | | | |
| FPS ZPT slurry | — | — | — | 0.5 | 0.2 |
| Glycerin | 0.3 | 0.3 | 0.3 | 0.3 | 0.3 |
| Palm kernel acid | 0.21 | 0.21 | 0.21 | 0.21 | 0.21 |
| Tallow acid | 0.14 | 0.14 | 0.14 | 0.14 | 0.14 |
| EDTA | 0.05 | 0.05 | 0.05 | 0.05 | 0.05 |
| Minors-Byproducts | 0.28 | 0.28 | 0.28 | 0.28 | 0.28 |

### Example 9

### Micellar Body Wash

A micellar body wash is prepared comprising dried zinc pyrithione. Surfactants can be added with excess water and stirred until homogenous. A polymer can be added from a 20% solution, and then all other ingredients can be added, except for salt and Ethylene glycol distearate (EGDS), which are added and stirred until homogeneous. EGDS is separately prepared by precipitating from a hot solution as a concentrate with SLS and added as a concentrated premix. The pH is adjusted to 6.0. Sodium chloride is added last to obtain a Brookfield viscosity of 9,000 cP at 2.0 l/seconds shear rate.

| | |
|---|---|
| sodium laureth-1 sulfate | 9.50 |
| cocamidopropyl betaine | 1.50 |
| citric acid | 0.34 |
| Polyquaternium 76 | 0.30 |
| EGDS | 3.50 |
| Dried ZPT | 1.00 |
| zinc carbonate | 1.50 |
| sodium chloride | 1.25 |
| fragrance | 1.00 |
| preservatives | 0.41 |
| water | QS |

### Example 10

### Structured Surfactant Body Wash

Skin Benefit Components and Thickeners

| Water, distilled | QS |
|---|---|
| Glycerin | 0.8 |
| Guar hydroxypropropyl-trimonium chloride(N-Hance 3196, | 0.7 |
| Aqualon) | |
| PEG 90M (Polyox WSR 301, Amerchol Corp) | 0.2 |
| Citric acid | 0.4 |
| Miracare SLB-365 (Rhodia, Inc.: Sodium Trideceth Sulfate, | 23.7 |
| Sodium Laurampho-acetate, Cocamide MEA) | |
| Fragrance | 1.4 |
| Soybean oil | 5 |
| Sodium chloride | 3.5 |
| Preservatives | 0.45 |
| Dried ZPT | 0.5 |
| Final pH (adjust using NaOH or citric acid) | 6.2 |
| Zero shear viscosity, Pa-sec | 6,530 |

The cleansing phase can be prepared by conventional formulation and mixing techniques. Prepare the cleansing phase by first adding water, skin benefit components, and thickeners into a mixing vessel and agitate until a homogeneous dispersion is formed. Then add in the following sequence: surfactants, Disodium EDTA, preservative and half the sodium chloride and all other preservatives and minors, except fragrance and the withheld sodium chloride. Maintain at ambient temperature while agitating the mixing vessel. In a separate vessel, pre-wet the structuring polymers with fragrance and add to the mix vessel at the same time as the remaining sodium chloride while agitating. Add the dried zinc pyrithione and soybean oil. Keep agitation until homogeneous, and then pump through a static mixing element to disperse any polymer lumps to complete the batch.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A personal care composition comprising dried zinc pyrithione.

2. The personal care composition of claim 1, wherein the dried zinc pyrithione comprises a moisture content of about 15% or less, by weight of the dried zinc pyrithione.

3. The personal care composition of claim 1, wherein the dried zinc pyrithione is formed from a spray drying process.

4. The personal care composition of claim 1, wherein the dried zinc pyrithione is in the form of particulates, platelets, or a combination thereof.

5. The method of claim 4, wherein the particulates comprise an average particle size from about 0.1 μm to about 20 μm.

6. The personal care composition of claim 5, wherein the particulates comprises an average particle size from about 0.5 μm to about 10 μm.

7. The personal care composition of claim 1, wherein the dried zinc pyrithione comprises a moisture content of about 10% or less, by weight of the dried zinc pyrithione.

8. The personal care composition of claim 1 further comprising a cleansing phase, wherein the cleansing phase comprises at least one surfactant.

9. The personal care composition of claim 8, wherein the at least one surfactant is selected from the group consisting of sodium laureth sulfate, sodium lauryl sulfate, sodium trideceth sulfate, and combinations thereof.

10. The personal care composition of claim 1, wherein the composition is a bar soap and further comprises:
a) from about 0.1% to about 35%, by weight of the personal care composition, of water;
b) from about 45% to about 99%, by weight of the personal care composition, of soap;
c) from about 0.01% to about 5%, by weight of the personal care composition, of the dried zinc pyrithione.

11. The personal care composition of claim 10, wherein the soap comprises one or more of coconut, tallow, palm, and palm kernel fatty acid.

12. The personal care composition of claim 1 comprising from about 0.05% to about 2%, by weight of the personal care composition, of the dried zinc pyrithione.

13. A method of increasing antimicrobial efficacy of zinc pyrithione, the method comprising drying zinc pyrithione to less than 25% moisture, by weight of the zinc pyrithione.

14. The method of claim 13, wherein the dried zinc pyrithione comprises less than about 10% moisture, by weight of the zinc pyrithione.

15. The method of claim 13, wherein the dried zinc pyrithione is spray dried.

16. A method of enhancing deposition of zinc pyrithione, the method comprising applying a personal care composition to the skin of an individual, the personal care composition comprising dried zinc pyrithione.

17. The method of claim 16, wherein the personal care composition comprises from about 0.05% to about 2%, by weight of the personal care composition, of the dried zinc pyrithione.

18. The method of claim 16, wherein the dried zinc pyrithione comprises about 15% or less, by weight of the dried zinc pyrithione, of moisture.

19. The method of claim 18, wherein about 0.05 μg/cm² or greater of the dried zinc pyrithione is deposited to the skin of the individual.

20. The method of claim 18, wherein from about 0.1 μg/cm² to about 1.0 μg/cm² of the dried zinc pyrithione is deposited to the skin of the individual.
